(19) United States
(12) Patent Application Publication
(10) Pub. No.: US 2013/0260102 A1
(43) Pub. Date: Oct. 3, 2013

(54) SURFACE TREATMENT METHOD FOR SUBSTRATE AND COATED ARTICLE MENUFACTURED BY THE METHOD

(71) Applicant: KAI-RONG LIAO, Shenzhen City (CN)

(72) Inventor: KAI-RONG LIAO, Shenzhen City (CN)

(21) Appl. No.: 13/655,642

(22) Filed: Oct. 19, 2012

(30) Foreign Application Priority Data
Mar. 29, 2012 (CN) 201210087719.4

(51) Int. Cl. B05D 5/06; B05D 5/02; B32B 3/26

(52) U.S. Cl. 428/172; 427/265

(57) ABSTRACT

A surface treatment method for substrate include following steps: a substrate is provided; a color layer is formed on the substrate by printing or spraying, the color layer includes a first region and a second region, a portion of the first region is adjacent to a portion of the second region, a junction is formed between the first and second regions, the color of the first region is different from the color of the second region; a paint layer is sprayed on the color layer, the thickness of the paint layer gradually decreasing with the distance from the junction to the two opposite sides of the color layer. A coated article manufactured by the method is also provided.

### BACKGROUND

1. Technical Field

The exemplary disclosure generally relates to a surface treatment method for substrate, especially to a surface treatment method which makes the substrate present gradually changing colors and a coated article manufactured by the method.

2. Description of Related Art

Housings of portable electronic devices may be decorated by forming layers which have gradually changing colors on the housings. The layer may be formed by printing using an automatic gradually changing printing machine. However, when the layer has a small area, the color difference between different regions of the layer cannot present a strong contrast. Another conventional way to form the layer may be carried out by respectively printing different color inks on different regions of the surface of the housing. However, the junction of each two different colors usually presents an unnatural transitivity.

Therefore, there is room for improvement within the art.

### BRIEF DESCRIPTION OF THE DRAWINGS

Many aspects of the embodiments may be better understood with reference to the following drawings. The components in the drawings are not necessarily drawn to scale, the emphasis instead being placed upon clearly illustrating the principles of the exemplary disclosure. Moreover, in the drawings, like reference numerals designate corresponding parts throughout the several views. Wherever possible, the same reference numbers are used throughout the drawings to refer to the same or like elements of an embodiment.

FIG. 1 is a schematic view of an exemplary embodiment of a shielding element.

FIG. 2 is a schematic view showing the shielding element of FIG. 1 at a working state.

FIG. 3 is a cross-sectional view of a first exemplary embodiment of a coated article.

FIG. 4 is a cross-sectional view of a second exemplary embodiment of a coated article.

### DETAILED DESCRIPTION

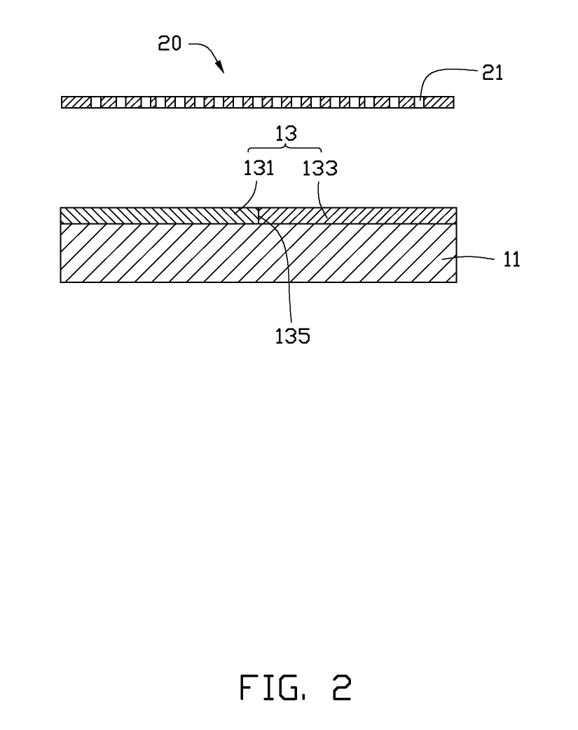

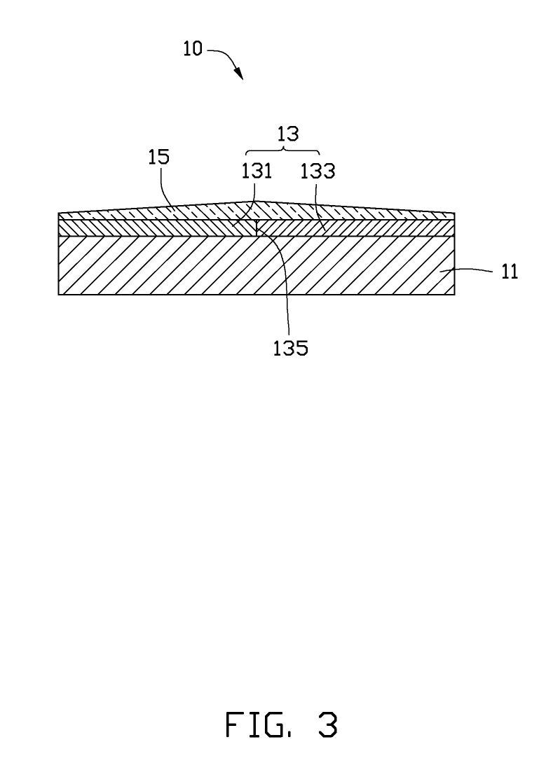

Referring to FIGS. 2 and 3, a first exemplary embodiment of a surface treatment method for substrate to make the substrate present gradually changing colors may include at least the following steps:

A substrate 11 is provided. The substrate 11 may be made of metal or non-metal.

The substrate 11 is degreased to remove contaminants of the substrate 11, such as grease or dirt.

A color layer 13 is formed on the substrate 11 by printing or spraying. The color layer 13 includes a first region 131 and a second region 133. The first region 131 is adjacent to the second region 133, and a junction 135 is formed between the first and second regions. The color of the first region 131 is different from the second area 133. The first region 131 has gradually changing colors. The second area 133 has other gradually changing colors.

A paint layer 15 has a matt appearance is sprayed on the color layer 13. The paint layer 15 is translucent. The thickness of the paint layer 15 is gradually decreasing from near the junction 135 to away from the junction 135. The thickness of the paint layer 15 at the junction 135 is about 4-4.5 μm.

The paint layer 15 is formed by the following steps:

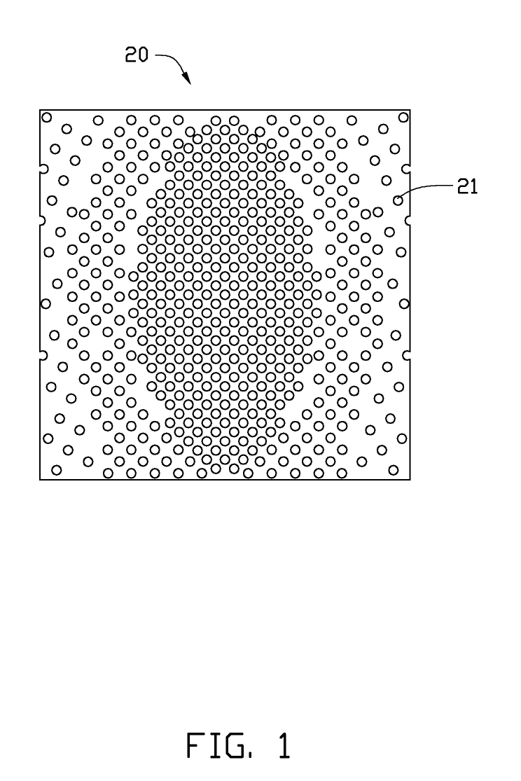

Referring to FIG. 1, a shielding element 20 is provided. The shielding element 20 defines a plurality of through holes 21. The distribution of the through holes 21 gradually decreases with the distance from the center portion of the shielding element 20 to the two opposite sides of the shielding element 20.

The shielding element 20 is positioned on the substrate 11, allowing the center portion of the shielding element 20 to cover on the junction 135.

A spray gun (not shown) and a paint having a matt appearance are provided. The paint is sprayed on the substrate 11 through the through holes 21 by the spray gun. During spraying, the distance between the substrate 11 and the spray gun is about 10 cm to about 20 cm. After spraying, the paint is solidified at an internal oven temperature of about 75-95° C. for about 40-50 min.

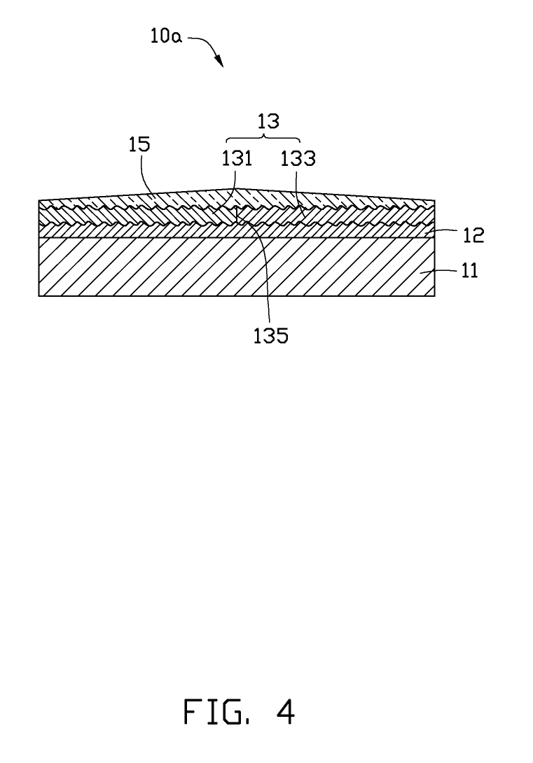

Referring to FIG. 4, a second exemplary embodiment of a surface treatment method for substrate may further include steps of forming an anode layer 12 on the substrate 11, and sealing the anode recesses of the anode layer 12, before forming the color layer 13. The substrate 11 may be made of aluminum alloy, titanium alloy, or the like.

Referring to FIG. 3, a coated article manufactured by the method is also provided. The coated article 10 includes a substrate 11, a color layer 13 formed on the substrate 11, and a paint layer 15 formed on the color layer 13.

The substrate 11 may be made of metal or non-metal.

The color layer 13 includes a first region 131 and a second region 133. The color layer 13 includes a first region 131 and a second region 133. The first region 131 is adjacent to the second region 133, and a junction 135 is formed between the first and second regions. The color of the first region 131 is different from the second area 133. The color of the first region 131 is different from the second area 133. The first region 131 has gradually changing colors, the second area 133 has another gradually changing colors.

The paint layer 15 is translucent. The paint layer 15 is a continuous layer. The thickness of the paint layer 15 gradually decreases with the distance from the junction 135 to the two opposite sides of the color layer 13. The thickness of the paint layer 15 is greatest at the junction 135 with the thickness about 4-4.5 μm.

Referring to FIG. 4, in the second exemplary embodiment, a coated article 10a further includes an anode layer 12 formed between the color layer 13 and the substrate 11. The substrate 11 may be made of aluminum alloy or titanium alloy.

The thickness of the paint layer 15 which has a matt appearance gradually decreasing with the distance from the junction 135 to the two opposite sides of the color layer 13, and thus is blurred in the area of the junction 135 due to the greatest thickness of the paint layer 15 and provides the coated article 10/10a with an appearance of more naturally gradually changing colors. Furthermore, the surface treatment method is simple.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A surface treatment method for substrate comprising:
providing a substrate;
forming a color layer on the substrate, the color layer comprising a first region and a second region, a portion of the first region being adjacent to a portion of the second region, a junction being formed between the first and second regions, the color of the first region being different from the color of the second region;
spraying a paint layer having a matt appearance on the color layer, the paint layer being translucent, the thickness of the paint layer gradually decreasing with the distance from the junction to the two opposite sides of the color layer.

2. The method of claim 1, wherein the color layer is formed by printing or spraying.

3. The method of claim 1, wherein the paint layer is formed by the following steps:
providing a shielding element, the shielding element defining a plurality of through holes, the distribution of the through holes gradually decreasing with the distance from the center portion of the shielding element to the two opposite sides of the shielding element;
positioning the shielding element on the substrate, allowing the center portion of the shielding element to cover on the junction; and
using the spray gun to spray paint on the substrate through the through holes.

4. The method of claim 1, wherein during spraying the paint layer, the distance between the substrate and the spray gun is about 10 cm to about 20 cm.

5. The method of claim 4, wherein after spraying, the paint is solidified at an internal oven temperature of about 75-95° C. for about 40-50 min.

6. The method of claim 1, wherein the method further includes a step of forming an anode layer on the substrate before forming the color layer.

7. A coated article, comprising:
a substrate;
a color layer formed on the substrate, the color layer comprising a first region and a second region, a portion of the first region being adjacent to a portion of the second region, a junction being formed between the first and second regions, the color of the first region being different from the color of the second region; and
a paint layer having a matt appearance formed on the color layer, the paint layer being translucent, the thickness of the paint layer gradually decreasing with the distance from the junction to the two opposite sides of the color layer.

8. The coated article as claimed in claim 7, wherein the thickness of the paint layer at the junction is about 4-4.5 μm.

9. The coated article as claimed in claim 7, wherein the coated article further includes an anode layer formed between the substrate and the color layer.

10. The coated article as claimed in claim 7, wherein the substrate is made of aluminum alloy or titanium alloy.
